(19) United States
(12) Patent Application Publication
(10) Pub. No.: US 2009/0106554 A1
(43) Pub. Date: Apr. 23, 2009

(54) E-MAIL RELAY APPARATUS AND E-MAIL RELAY METHOD

(75) Inventor: Yusuke Mochizuki, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Minami-ku (JP)

(21) Appl. No.: 12/187,552

(22) Filed: Aug. 7, 2008

(30) Foreign Application Priority Data
Oct. 18, 2007 (JP) 2007-271224

(51) Int. Cl. H04L 9/06

(52) U.S. Cl. 713/176

(57) ABSTRACT

An e-mail relay apparatus notifies a user of which e-mail could not be transmitted if a transmission error has occurred, without consuming a memory capacity. When an e-mail transmission instruction is received and after header information of the received e-mail is stored, a digital signature is added to the e-mail, and the e-mail text is encrypted. Then, after the digital signature is added, the encrypted e-mail is stored, and after the original e-mail is deleted, the transmission of the e-mail is started. If an error has occurred during the e-mail transmission and the transmission has failed, an error-notifying mail addressed to a transmission source is generated. After a header file of the e-mail is attached to the error-notifying mail, the error-notifying mail to which the header file is attached is stored in a mail box for the user of the transmission source.

### CROSS-REFERENCE TO RELATED APPLICATION

This application claims priority under 35 U.S.C. 119 to Japanese Patent Application No. 2007-271224, filed on Oct. 18, 2007, which application is hereby incorporated by reference in its entirety.

### BACKGROUND OF THE INVENTION

1. Field of the Invention

The present invention relates to an electronic mail (e-mail) relay apparatus and, in particular, to an e-mail relay apparatus that encrypts an e-mail and provides a digital signature.

2. Description of the Related Art

When a sender transmits an e-mail by a computer system, the required processes include processes such as storing the email in a mail server that manages an address of a destination, retrieval of the e-mail by a communication terminal at a receiving party to confirm the content thereof, and deletion of the e-mail, if necessary.

Convenience and promptness have made e-mail an indispensable tool for business communication in the field of business and other similar fields. However, there is a risk that an e-mail could be intercepted, rewritten, altered, and passed off as another's e-mail. Therefore, an e-mail is encrypted and/or provided with a digital signature by using a Public Key Infrastructure (PKI), or other similar encryption system. As the PKI, the common key cryptosystem and the public key cryptosystem are generally known. When encrypting and decrypting an e-mail, the common key cryptosystem uses a common key (cryptographic algorithm), and the public key cryptosystem uses different keys (a public key for encryption, and a private key for decryption).

A public key is a cryptographic key that has been formally certified by a Certificate Authority (CA), for example, as having a relationship with a user, i.e., a holder thereof, and opened to the general public. A private key is a cryptographic key that is a counterpart of a public key. A message encrypted with the public key can be decrypted only with the private key, and a message encrypted with the private key can be decrypted only with the public key. Thus, an encrypted e-mail is created by using a public key, and a digital signature can be provided by using a private key.

A certificate issued by the above-described CA is data that certifies a public key as authentic and certifies that the public key is authentic. Accordingly, by using the public key which has been certified as authentic by the certificate, a digital signature provided by using a private key that is a counterpart of the public key can be verified, making it possible to detect whether or not data has been altered.

When performing the encryption or providing the digital signature as described above, it is troublesome for a sender and a recipient of an e-mail to manage a cryptographic key and use software. Therefore, it has been considered to perform the encryption or other similar modification of an e-mail by using an e-mail relay apparatus such as a gateway server.

When an error occurs in an e-mail server or other similar device during transmission of an e-mail to the sender of the e-mail, an e-mail that provides notice of the transmission error occurrence is created and transmitted.

As described above, should any error occur during e-mail transmission, it is necessary to provide notice of the transmission error occurrence. However, the user cannot determine which e-mail could not be transmitted only by being notified of the error. If the original e-mail is attached to the error notifying e-mail, the user can determine which e-mail could not be transmitted. However, such a method requires that the original e-mail be stored until the transmission of the error-notifying e-mail is completed.

However, when storing original e-mails in an e-mail relay apparatus such as a gateway server that encrypts e-mails and provides digital signatures, problems arise in that a memory capacity of the gateway server is consumed or in that the traffic of the gateway server increases. More specifically, a gateway server generally does not have a large memory capacity, and an original e-mail can have a large size due to an attached file. Therefore, the memory capacity of the gateway server is consumed or the traffic of the gateway server increases.

### SUMMARY OF THE INVENTION

In order to overcome the problems described above, preferred embodiments of the present invention provide an e-mail relay apparatus that can notify, at the time of transmission error occurrence, a user of which e-mail could not be transmitted without consuming a memory capacity.

In order to overcome the problems described above, an e-mail relay apparatus according to a preferred embodiment of the present invention includes an e-mail acquiring unit arranged to acquire an e-mail having a specified transmission destination address, a digital signature processing unit arranged to provide a digital signature to the e-mail acquired by the e-mail acquiring unit, an encryption processing unit arranged to encrypt the e-mail acquired by the e-mail acquiring unit, an e-mail transmitting unit arranged to transmit the encrypted e-mail provided with the digital signature, and a control unit arranged to control each of the above-described units. When the e-mail acquiring unit acquires the e-mail, the control unit stores a header portion of the e-mail, and deletes the original e-mail after executing the encryption of the e-mail and providing the e-mail with the digital signature by instructing the digital signature processing unit and the encryption processing unit. Moreover, if an error occurs while the e-mail transmitting unit is transmitting the e-mail, the control unit transmits to a transmission source address an error-notifying mail to which a file of the stored header portion is attached.

The e-mail relay apparatus according to a preferred embodiment of the present invention includes an e-mail box preferably provided for each user, and the control unit stores the error-notifying mail in the e-mail box for the user of the transmission source. When the user of the transmission source performs e-mail reception, the control unit instructs the e-mail transmitting unit to distribute the error notifying mail. Further, in the e-mail relay apparatus, the digital signature processing unit and the encryption processing unit provide the digital signature to the e-mail and encrypt the e-mail by using the PKI.

In the e-mail relay apparatus according to a preferred embodiment of the present invention, the header portion of the e-mail is stored when the e-mail is acquired, and the original e-mail is deleted after the e-mail is provided with the digital signature and encrypted. If an error occurs at the time of e-mail transmission, the error-notifying mail to which the file of the stored header portion is attached is transmitted to the transmission source address. Accordingly, without consuming the memory capacity of the e-mail relay apparatus, the user can be notified of which e-mail could not be transmitted.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates an example of a network configuration of a system including a gateway server.

FIG. 2 is a functional block diagram illustrating a function of the gateway server.

FIG. 3 illustrates an example of a stored content of a key information managing unit.

FIG. 4 illustrates an example of a certificate storage table of a public key certificate storage unit.

FIG. 5 illustrates an example of a format of a public key certificate.

FIG. 6 is a flowchart of processes taken when an e-mail is transmitted.

FIG. 7 is a flowchart of processes taken when an e-mail is received.

### DETAILED DESCRIPTION OF PREFERRED EMBODIMENTS

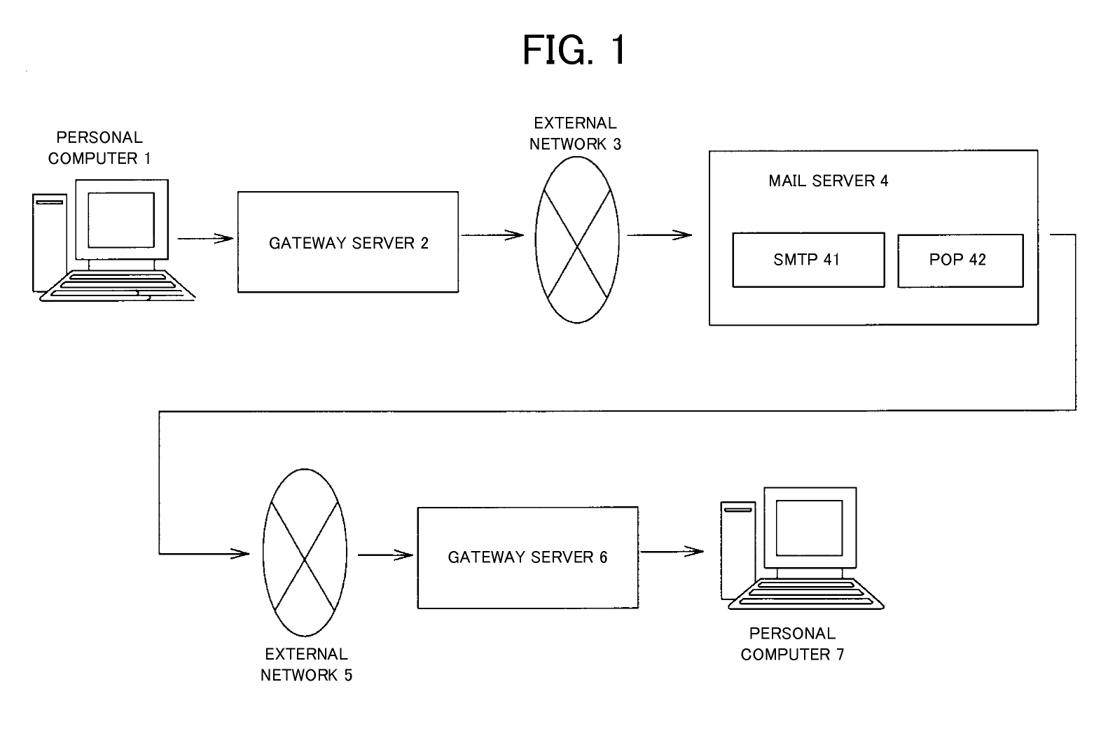

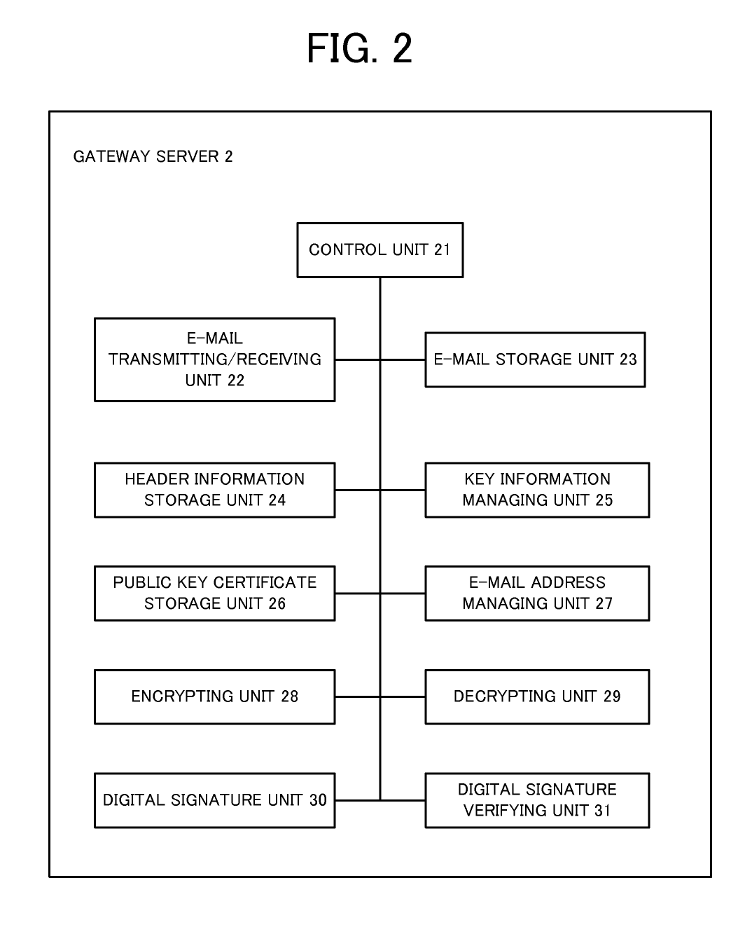

With reference to the drawings, an e-mail relay apparatus according to preferred embodiments of the present invention will be described. FIG. 1 illustrates an example of a network configuration of a system including a gateway server to which the e-mail relay apparatus according to a preferred embodiment of the present invention is applied. FIG. 2 is a functional block diagram illustrating a function of the gateway server.

In the network configuration in FIG. 1, reference numerals 1 and 7 denote personal computers, 2 and 6 denote gateway servers, 3 and 5 denote external networks such as the Internet, and 4 denotes a mail server. Along with other personal computers, the personal computers 1 and 7 are connected with the gateway servers 2 and 6 via a communication network such as a Local Area Network (LAN). It is possible that the personal computers are wirelessly connected to the gateway servers 2 and 6. It is also possible that other devices that are capable of sending and receiving e-mails, e.g., Personal Digital Assistants (PDA) and smart phones, are connected to the gateway servers 2 and 6. The mail server 4 typically includes a Simple Mail Transfer Protocol (SMTP) 41 and a Post Office Protocol (POP) 42. An e-mail from the gateway servers 2 and 6 is received by the SMTP 41, and then distributed to a server of an e-mail destination. Accordingly, the e-mail addressed to the POP 42 is transferred from the SMTP 41 to the POP 42.

FIG. 2 is a functional block diagram illustrating a function of the gateway server 2. The gateway server 2 includes a control unit 21, an e-mail transmitting/receiving unit 22, an e-mail storage unit 23, a header information storage unit 24, a key information managing unit 25, a public key certificate storage unit 26, an e-mail address managing unit 27, an encrypting unit 28, a decrypting unit 29, a digital signature unit 30, and a digital signature verifying unit 31. Each of the units is configured by a Central Processing Unit (CPU), a Read Only Memory (ROM), and a Random Access Memory (RAM), and functions thereof are executed by a software program.

The control unit 21 preferably controls the entire gateway server 2. The e-mail transmitting/receiving unit 22 receives an e-mail transmitted from an external mail server or the personal computer 1 and transmits the received e-mail to a specified transmission destination. The e-mail transmitting/receiving unit 22 executes functions of an e-mail acquiring unit and an e-mail transmitting unit of the e-mail relay apparatus of the preferred embodiment of the present invention.

The e-mail storage unit 23 includes a mail box that has been set for each user. Attached files or other similar attachments transmitted/received along with transmitted/received e-mail documents and e-mails are stored in the mail box. When the e-mail transmitting/receiving unit 22 receives an e-mail transmitted from the personal computer 1 or other similar device, the header information storage unit 24 stores a header portion of the e-mail.

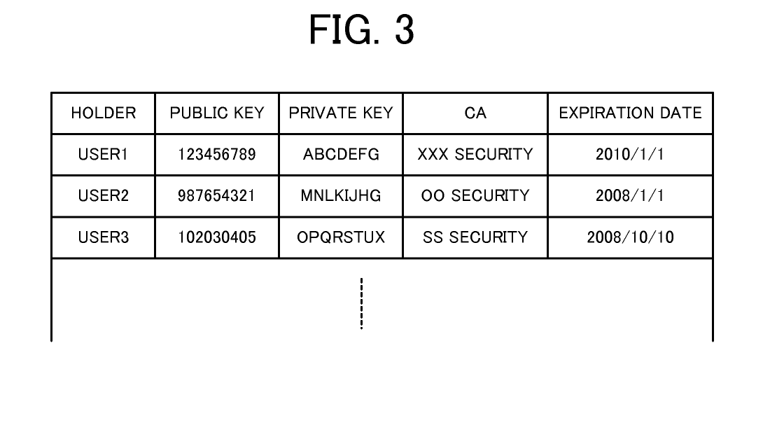

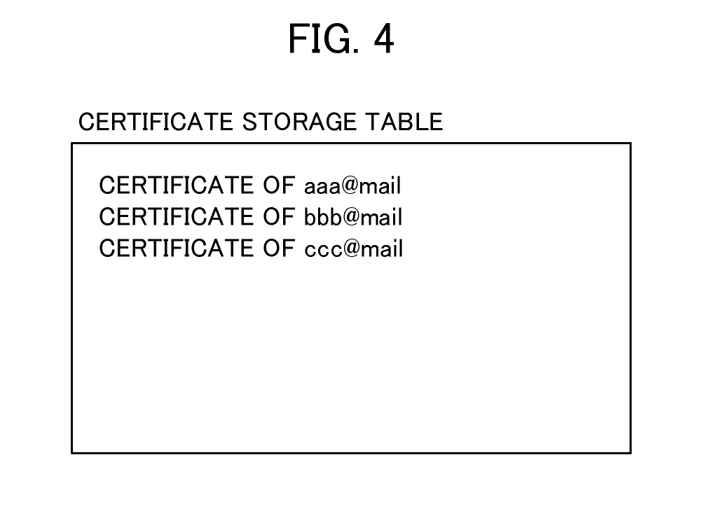

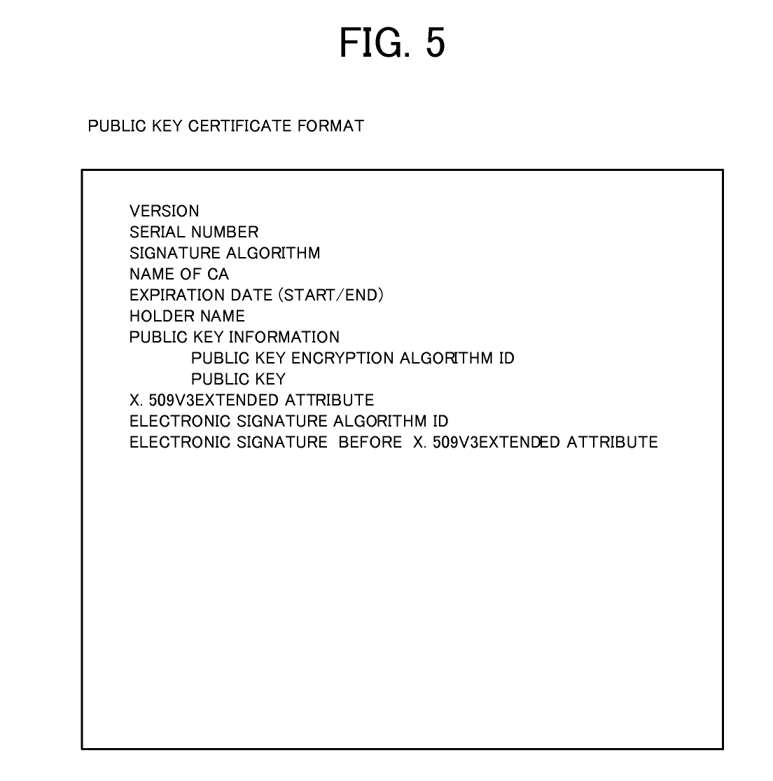

As illustrated in FIG. 3, the key information managing unit 25 stores a table of key information such as a public key, a private key, a CA name, and an expiration date specified with respect to each user. As illustrated in FIG. 4, the public key certificate storage unit 26 stores a public key certificate transmitted from the transmission source or issued by a CA. The public key certificate of the CA is provided with a digital signature by a private key of the CA with respect to a holder name, an e-mail address, and the public key. As illustrated in FIG. 5, in the public key certificate, a version of cryptographic software, a serial number, a signature algorithm, the CA name, the expiration date, the holder name, and the public key information, and other similar information can be described.

The e-mail address managing unit 27 manages an e-mail address of each transmission destination to which an e-mail is transmitted. The encrypting unit 28 encrypts an e-mail with a public key of a transmission destination. The decrypting unit 29 decrypts the encrypted e-mail with a private key of each user stored in the key information managing unit 25. The digital signature unit 30 generates a digital signature for an e-mail to be transmitted by using the private key of each user. The digital signature verifying unit 31 verifies the digital signature attached to the e-mail by using the public key certificate of the transmission source of the received e-mail to confirm that the e-mail is error free, in other words, to confirm that the e-mail has not been altered.

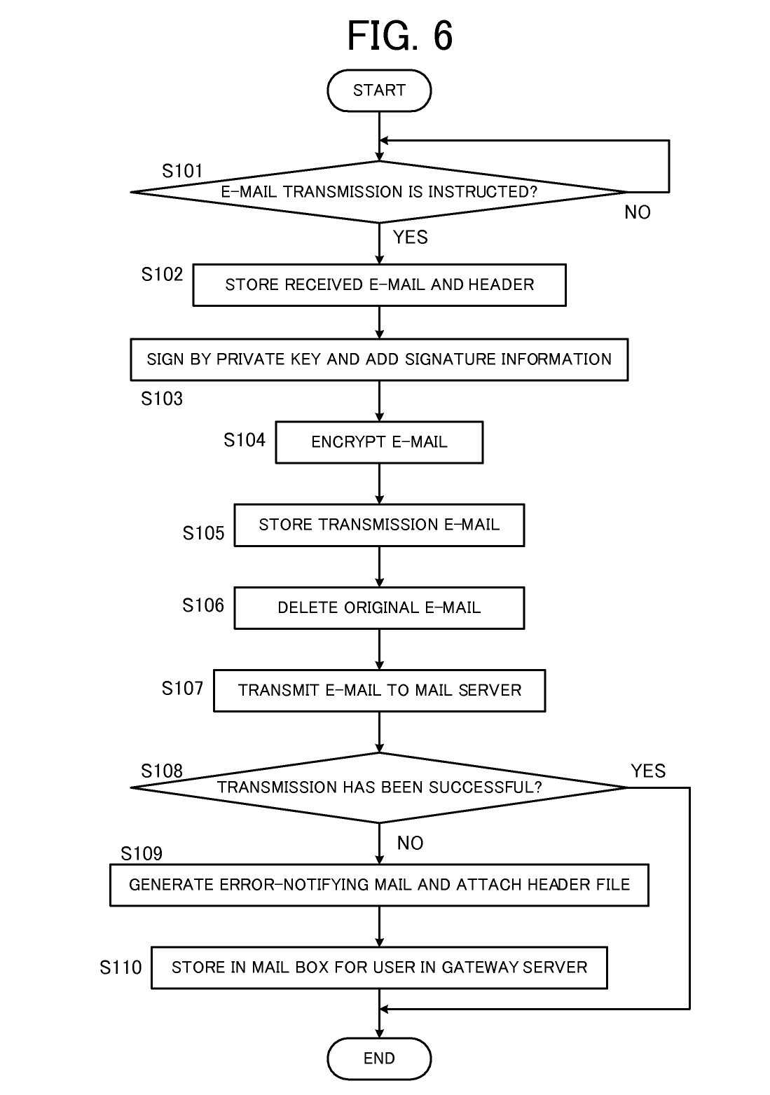

The gateway server 2 is configured as described above. Next, with reference to the flowchart in FIG. 6, the processes performed when an e-mail is transmitted will be described. The control unit 21 of the gateway server 2 executes an e-mail transmission program illustrated in FIG. 6 to determine if an e-mail transmission instruction has been received from the personal computer 1 or other suitable device at all times (step 101). Then, when an e-mail transmission instruction is received from the personal computer 1, for example, the control unit 21 stores a received e-mail in the e-mail storage unit 23, and also stores header information of the received e-mail in the header information storage unit 24 (step 102). An e-mail includes header information and mail text. The header information includes, for example, “Data”, which indicates transmission date and time of the e-mail, “To”, which indicates a destination of the e-mail, “From”, which indicates a sender of the e-mail, and “Subject”, which indicates additional information such as a subject name of the e-mail.

Next, the control unit 21 reads out the e-mail received from the e-mail storage unit 23, instructs the digital signature unit 30 to generate a digital signature, and adds the generated digital signature to the e-mail (step 103). In other words, the digital signature unit 30 generates a message digest from the entire e-mail by using a hash function (one-way summary function). The digital signature unit 30 then encrypts the generated message digest with a private key of the sending user, for example, USER 1, which is managed in the key information unit 25.

After the digital signature is added to the e-mail in step 103, the control unit 21 instructs the encrypting unit 28 to encrypt the e-mail text (step 104). In other words, the encrypting unit 28 uses the public key information of the destination registered in the public key certificate storage unit 26 to convert the e-mail text into an encrypted e-mail.

After the encryption of the e-mail text is completed, and after the digital signature is added and the encrypted e-mail is stored in the e-mail storage unit 23 (step 105), the control unit 21 deletes the original e-mail from the e-mail storage unit 23 (step 106). Then, the control unit 21 instructs the e-mail transmitting/receiving unit 22 to transmit the encrypted e-mail to which the digital signature is added to the e-mail address of the transmission destination via the external network 3 (step 107).

After the e-mail transmission is started, the control unit 21 determines if an error has occurred during the transmission of the encrypted e-mail to which the digital signature is added. Thus, the control unit 21 determines if the e-mail transmission has been successful (step 108). When the transmission is successful without any error occurring, the control unit 21 ends the e-mail transmission program.

If an error has occurred and the transmission has failed, the control unit 21 generates an error-notifying e-mail for the transmission source and attaches to the error-notifying mail a header file of the relevant e-mail stored in the header information storage unit 24 (step 109). Then, the control unit 21 stores the error-notifying mail to which the header file is attached in the mail box set for the user of the transmission source of the e-mail storage unit 23 (step 110).

Thus, by accessing the gateway server to receive an e-mail, the user of the personal computer 1 can receive the error-notifying mail to which the header file is attached and can easily recognize which e-mail could not be transmitted. Moreover, at the time of reception of the e-mail, after the digital signature is added and the e-mail is encrypted, the original e-mail is deleted from the e-mail storage unit 23. Therefore, a memory capacity of the gateway server is not used.

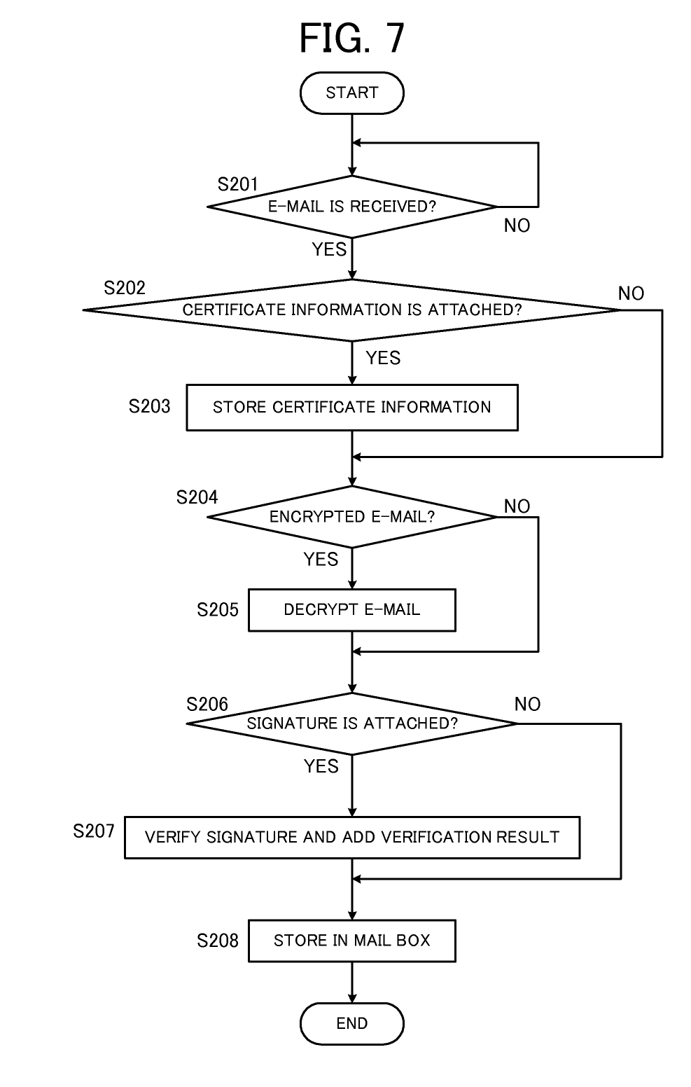

Next, with reference to the flowchart of FIG. 7, the processes of the control unit 21 performed when an e-mail is received via the external network 3 or other suitable network will be explained. The control unit 21 executes an e-mail receiving program of the flowchart in FIG. 7 and determines if an e-mail has been received at all times (step 201). When the e-mail transmitting/receiving unit 22 receives an e-mail, the control unit 21 determines if the public key certificate information is attached to the received e-mail (step 202). If it is determined that the certificate information is attached to the received e-mail, the control unit 21 stores the certificate information in the public key certificate storage unit 26 (step 203).

After the public key certificate information is stored in step 203, or if it is determined in step 202 that certificate information is not attached to the received e-mail, the control unit 21 determines if the received e-mail is encrypted (step 204). When it is determined that the received e-mail is the encrypted e-mail, the control unit 21 reads out a “FROM (transmission source) field” and a “TO (transmission destination) field” from the e-mail, specifies the transmission source and the transmission destination, and causes the decrypting unit 29 to decrypt the encrypted e-mail (step 205). In other words, the decrypting unit 29 decrypts the encrypted e-mail by using a private key of the user of the transmission destination, for example, USER 2, stored in the key information managing unit 25.

After the e-mail is decrypted in step 205, or if it is determined in step 204 that the received e-mail is not encrypted, the control unit 21 determines if the digital signature is attached to the e-mail (step 206). If it is determined that the digital signature is attached, the control unit instructs the digital signature verifying unit 31 to execute the verification of the digital signature and adds a verification result to the decrypted e-mail or to the received e-mail (step 207).

In other words, the digital signature verifying unit 31 specifies the transmission source by reading out the “FROM (transmission source) field” described in the header portion of the e-mail. Then, the digital signature verifying unit 31 searches for addresses in the public key certificate storage unit 26 from the address of the specified transmission source to select its public key. Then, by using the public key, the digital signature verifying unit 31 decrypts the digital signature to generate a message digest. When the public key certificate information of the transmission source is not stored in the public key certificate storage unit 26, the certificate information is acquired via the external network 3 from the CA based on the address of the transmission source and is then used. The acquired public key certificate is stored in the public key certificate storage unit 26.

Then, the digital signature verifying unit 31 generates a message digest from the entire e-mail by using the same hash function as that of the transmission source. The digital signature verifying unit 31 compares the decrypted message digest on the transmission side with the message digest on the reception side generated from the e-mail to determine if the digests match with each other. Thus, the digital signature verifying unit 31 determines if the e-mail has been altered. Based on this determination, the control unit 21 adds to the e-mail the digital signature verified result including, for example, a comment such as “this e-mail is the genuine e-mail” and signature content.

After adding the verified result of the digital signature in step 207 or if it is determined in step 206 that the signature is not attached, the control unit 21 stores the e-mail in the mail box for the recipient user of the e-mail storage unit 23 (S208).

In the above-described preferred embodiment, an example is described in which the e-mail relay apparatus according to a preferred embodiment of the present invention is applied to the gateway server. However, the present invention can be applied to other e-mail relay apparatuses.

While the present invention has been described with respect to preferred embodiments thereof, it will be apparent to those skilled in the art that the disclosed invention can be modified in numerous ways and can assume many embodiments other than those specifically set out and described above. Accordingly, the appended claims are intended to cover all modifications of the present invention that fall within the true spirit and scope of the present invention.

What is claimed is:

1. An e-mail relay apparatus comprising:
an e-mail acquiring unit arranged to acquire an e-mail having a specified transmission destination address;
a digital signature processing unit arranged to provide a digital signature to the e-mail acquired by the e-mail acquiring unit;
an encryption processing unit arranged to encrypt the e-mail acquired by the e-mail acquiring unit;
an e-mail transmitting unit arranged to transmit the encrypted e-mail provided with the digital signature; and
a control unit arranged to control each of the units; wherein
when the e-mail acquiring unit acquires the e-mail, the control unit:
stores a header portion of the e-mail;
deletes the original e-mail after instructing the digital signature processing unit to provide a digital signature to the e-mail and the encryption processing unit to encrypt the e-mail, respectively; and
when an error occurs at the time of e-mail transmission performed by the e-mail transmitting unit, transmits to a transmission source address an error-notifying mail to which a file of the stored header portion is attached.

2. The e-mail relay apparatus according to claim 1 further comprising a mail box with respect to each user; wherein
the control unit stores the error-notifying mail in the mail box for a user of a transmission source; and
when the user of the transmission source performs e-mail reception, the control unit instructs the e-mail-transmitting unit to distribute the error-notifying mail.

3. The e-mail relay apparatus according to claim 2, wherein the e-mail is encrypted and provided with a digital signature by using a Public Key Infrastructure in the digital signature processing unit and the encryption processing unit.

4. An e-mail relay method comprising the steps of:
storing a header portion of an e-mail when the e-mail is acquired;
deleting the original e-mail after the e-mail is provided with a digital signature and encryption of the e-mail is executed; and
when an error occurs at the time of e-mail transmission, transmitting to a transmission source address an error-notifying mail to which a file of the stored header portion is attached.

5. The e-mail relay method according to claim 4, wherein the error-notifying mail is stored in a mail box for a user of the transmission source, and when the user of the transmission source performs e-mail reception, the error-notifying mail is distributed.

6. The e-mail relay method according to claim 5, wherein a digital signature is provided to the e-mail and encryption of the e-mail is performed by using a Public Key Infrastructure.
